(19) United States
(12) Patent Application Publication
(10) Pub. No.: US 2002/0180583 A1
(43) Pub. Date: Dec. 5, 2002

(54) Authentication of subscriber station

(75) Inventors: Lauri Paatero, Helsinki (FI); Janne Rantala, Espoo (FI)

Correspondence Address: AKIN, GUMP, STRAUSS, HAUER & FELD, L.L.P., ONE COMMERCE SQUARE, SUITE 2200, 2005 MARKET STREET, PHILADELPHIA, PA, 19103, US

(73) Assignee: SETEC OY

(21) Appl. No.: 10/126,741

(22) Filed: Apr. 19, 2002

Related U.S. Application Data
(63) Continuation of application No. PCT/FI00/00907, filed on Oct. 18, 2000.

(30) Foreign Application Priority Data
Oct. 19, 1999 (FI) 19992258
Dec. 2, 1999 (FI) 19992595

(51) Int. Cl. G06F 7/04

(52) U.S. Cl. 340/5.8

(57) ABSTRACT

The present invention relates to a telecommunication system comprising: at least one subscriber station in the memory of which a secret key is stored, and authentication means for authenticating the subscriber station. In order to make the subscriber-station-specific secret key even more difficult to crack, the subscriber station checks the correctness of a received input by computing a message authentication code utilizing the input and a checking algorithm and computes a response to be transmitted to the authentication means by the subscriber station utilizing an authentication algorithm, the secret key stored in the memory of the subscriber station and the input if the input is correct on the basis of the message authentication code.

### CROSS-REFERENCE TO RELATED APPLICATIONS

This application is a continuation of International Patent Application No. PCT/F100/00907, filed Oct. 18, 2000 which was published in the English language on Apr. 26, 2001, under International Publication No. WO 01/30104 A1, and the disclosure of which is incorporated herein by reference.

### BACKGROUND OF THE INVENTION

The present invention relates to authenticating a subscriber station, wherein the identity of the subscriber station is verified on the basis of a subscriber-station-specific secret key stored in the subscriber station. The invention particularly relates to a solution for identifying an authentication message generated by an external attacker, and for guaranteeing that no such information on processing such authentication message reaches the external attacker that would enable the attacker to crack the secret key.

The invention primarily relates to authenticating a subscriber station in a GSM (Global System for Mobile Communications) system. It is to be noted, however, that the invention may also be applied in other connections although in the following the invention will be described mainly referring to the GSM system.

In the GSM system, authentication of a subscriber station is based on a request-response procedure. For the authentication, a subscriber-station-specific secret key Ki and authentication algorithm A3 have been stored on the SIM (Subscriber Identity Module) card of the subscriber station. The subscriber-station-specific secret key Ki of the subscriber station and the corresponding authentication algorithm A3 have also been stored in an authentication centre of a GSM network. In order to carry out the authentication, a random number generator arranged in the authentication centre first generates a random number and transmits it to a counter as an input. Next, the counter computes a response SRES on the basis of the random number, authentication algorithm A3 and secret key Ki. The authentication centre then transmits the random number and the response SRES to a network element which carries out the actual authentication, which, as regards the GSM system, is a VLR (Visitor Location Register).

The visitor location register forwards the received random number to the subscriber station to be authenticated. The subscriber station comprises a counter, which computes a response SRES on the basis of the received random number, secret key Ki of the subscriber station and authentication algorithm A3, and the subscriber station transmits the response SRES to the VLR. The VLR then compares the response transmitted by the authentication centre with the response transmitted by the subscriber station. Since the secret key Ki stored in the memory of the subscriber station is subscriber-station-specific, there is only one subscriber station capable of generating a correct response to the input transmitted thereto. If the responses of the subscriber station and the authentication centre are identical, the subscriber station has thus been authenticated.

A drawback of the known authentication procedure described above is that it is possible for an external attacker who desires to crack the secret key stored in the subscriber station to try to crack the secret key by supplying different inputs to the subscriber station (or the SIM card thereof) again and again and monitoring the responses being transmitted from the subscriber station. When this procedure is repeated frequently enough and statistics is collected about the inputs and responses, the secret key Ki may be revealed on the basis of the collected data. If the external attacker cracks the key, he or she is capable of cloning the subscriber station (or the SIM card) by producing a second subscriber station which has an identical secret key, in which case the cloned subscriber station can be used for making calls, for which the owner of the original subscriber station is billed.

### BRIEF SUMMARY OF THE INVENTION

An object of the present invention is to alleviate the above-mentioned problem and to provide a solution owing to which it is more difficult for an external attacker to crack a secret key of a subscriber station. The object is achieved by a method of the invention for identifying an authentication message generated by an external attacker, the method comprising receiving the authenticating message comprising an input. The method of the invention is characterized by checking the correctness of the input by computing a message authentication code by utilizing the input and a checking algorithm, and identifying the authentication message as being generated by the external attacker if the input is incorrect on the basis of the message authentication code.

The invention further relates to a telecommunication system wherein a method of the invention can be utilized. The telecommunication system of the invention comprises: at least one subscriber station comprising a counter and a memory with a subscriber-stationspecific secret key stored therein, and authentication means for authenticating said subscriber station, the authentication means comprising a random number generator, a counter and a memory with the subscriber-station-specific secret key of said at least one subscriber station stored therein, the authentication means being arranged to: compute a response on the basis of an input, an authentication algorithm and the subscriber-station-specific secret key stored in the memory of the authentication means, transmit said input to said subscriber station, and indicate that the subscriber station has been authenticated if the authentication means receive from the subscriber station a response which corresponds to the response computed by the authentication means. The telecommunication system of the invention is characterized in that the authentication means are arranged to compute said input by utilizing a random number generated by the random number generator and a first algorithm, and that the subscriber station is arranged to check the correctness of the received input by computing a message authentication code by utilizing the input and a checking algorithm, compute a response to be transmitted to the authentication means by the subscriber station by utilizing the authentication algorithm, said secret key stored in the memory of the subscriber station and the input if the input is correct on the basis of the message authentication code.

The invention further relates to an authentication centre in a telecommunication system, the authentication centre comprising: a random number generator, a counter and a memory with subscriber-station-specific secret keys of subscriber stations stored therein, and generating an input and a response necessary for authenticating a particular subscriber station, Whereby in order to produce the response, the authentication centre is arranged to retrieve from the memory the secret key of the subscriber station to be authenticated and compute the response on the basis of the secret key retrieved from the memory, said input and an authentication algorithm. The authentication centre of the invention is characterized in that the authentication centre is arranged to produce said input by utilizing a random number generated by the random number generator and a first algorithm.

The invention still further relates to a subscriber station in a telecommunication system which, for authenticating the subscriber station, comprises: a memory with a secret key stored therein, means for receiving an input, and a counter. The subscriber station of the invention is characterized in that the subscriber station is arranged to check the correctness of the input by computing a message authentication code by utilizing the input and a checking algorithm, and the counter is arranged to compute a response to be forwarded by the subscriber station by utilizing an authentication algorithm, said secret key and said input if the input is correct on the basis of the message authentication code.

The invention still further relates to an SIM card comprising a counter and a memory with a secret key stored therein, and an inlet for receiving an input. The SIM card of the invention is characterized in that the SIM card is arranged to check the correctness of the received input by computing a message authentication code by utilizing the input and a checking algorithm, and compute a response to be forwarded by the SIM card by utilizing an authentication algorithm, said secret key and said input if the input is correct on the basis of the message authentication code.

The idea underlying the invention is that when, while authenticating a subscriber station, an input whose correctness can be checked by the subscriber station is used as the input instead of a random number, a solution for making it even more difficult to crack a subscriber-station-specific secret key is achieved. The subscriber station can then identify an incorrect input, i.e. an input which in all probability originates from an external attacker trying to crack the secret key of the subscriber station. According to the invention, the subscriber station can be programmed to operate such that cracking the secret key is made significantly more difficult when the subscriber station has identified an input originating from an external attacker.

The most important advantages of the solution of the invention thus are that it is even more difficult for the external attacker to crack the secret key used in authenticating a particular subscriber station, and that the invention can with extremely slight changes be applied to existing systems. In the GSM system, for example, the invention can be directly implemented in the authentication centre of the system, which means that new telephones can right from the start be equipped with SIM cards capable of checking the input according to the invention. It is not necessary to change the SIM cards in old telephones since the old SIM cards are capable of processing the input produced by an authentication centre operating according to the invention. The old telephones simply assume that the input is a random number to be processed as before in connection with authentication.

In a first preferred embodiment of the invention, the subscriber station produces and forwards an input only if the subscriber station has checked and concluded that the input is correct. Consequently, it is more difficult to crack the secret key since an external attacker does not know how to choose the input so that the checking carried out by the subscriber station would indicate that the input is correct. The authentication centre of the telecommunication system, for example, comprises information on the checking procedures used by the subscriber station, which means that the authentication centre is capable of producing an input to be transmitted to the subscriber station which is correct on the basis of the checking carried out by the subscriber station.

In a second preferred embodiment of the invention, the subscriber station computes and forwards a random response if it detects that the received input is incorrect. The random response may be computed by another algorithm than the authentication algorithm. Alternatively, the random response may be computed by the authentication algorithm but, instead of the secret key of the subscriber station, the computation utilizes another key which is a “pseudo key”, or, alternatively, the random response may comprise a random number generated by a random number generator. The point is that the random response resembles a real response such that an external attacker does not, on the basis of the length of the response, for example, know that the random response is not a real response equipped with an authentication algorithm and a secret key.

In a third preferred embodiment of the invention, the subscriber station maintains a counter function to compute the number of inputs that are incorrect on the basis of a message authentication code. In such a case, when a predetermined limit value is exceeded, the subscriber station locks such that it no longer provides a correct response to the input. In this embodiment, the subscriber station can thus produce and forward a response which is either correct or incorrect regardless of whether the input is correct until the counter function indicates that the maximum number of incorrect inputs is exceeded, whereby the authentication function of the subscriber station locks. The locking may take place either such that the subscriber station no longer provides responses at all or, alternatively, in order to mislead, the subscriber station may continue by producing incorrect responses only, such as random responses. This prevents the external attacker from having the possibility to crack the secret key of the subscriber station by utilizing statistics, for example.

The counter function of the subscriber station may be implemented, for example, such that when being set up, the counter function has been set to a certain initial value, and it has also been made sure that the counter function cannot be manipulated later (in order to reset the counter function to the initial value, for instance). Next, when the counter function of the subscriber station reaches a predetermined limit value which, depending on the application, may range from 100 to 10 000, its authentication functions will be permanently locked such that the subscriber station no longer provides correct responses. When the subscriber station is one in which the authentication functions are arranged on the SIM card, such as in a GSM mobile station, the subscriber station must next be provided with a new SIM card to replace the locked one.

Preferred embodiments of the method, system, subscriber station and SIM card of the invention are disclosed in the attached dependent claims 2 to 6, 8 to 11, 14 to 17, 19 and 20.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 is a is a flow diagram showing a first preferred embodiment of a method of the invention;

FIG. 2 is a block diagram showing a first preferred embodiment of a system of the invention;

FIG. 3 illustrates an input utilized in authenticating a subscriber station;

FIG. 4 is a is a flow diagram showing the first preferred embodiment of the method of the invention; and

FIG. 5 is a block diagram showing a third preferred embodiment of the system of the invention.

FIG. 6 is a flow diagram showing a second preferred embodiment of the method of the invention.

### DETAILED DESCRIPTION OF THE INVENTION

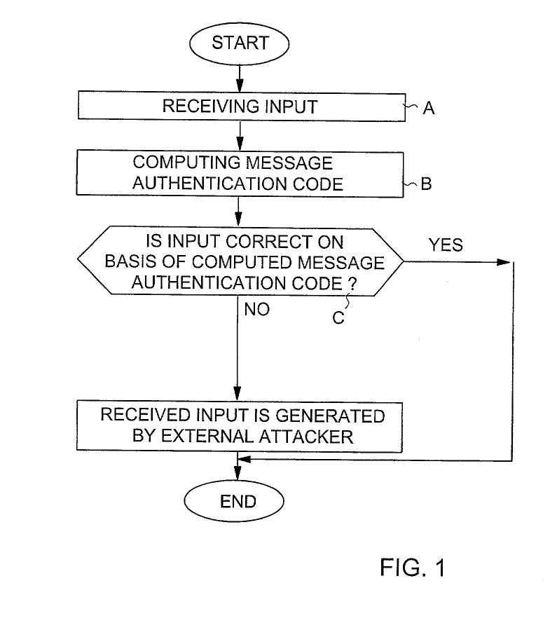

FIG. 1 is a flow diagram showing a first preferred embodiment of a method of the invention. The flow diagram of FIG. 1 can be utilized, for example, in processing an authentication message received by a GSM subscriber station/SIM card.

In block A in FIG. 1, an authentication message comprising an input RAND is received.

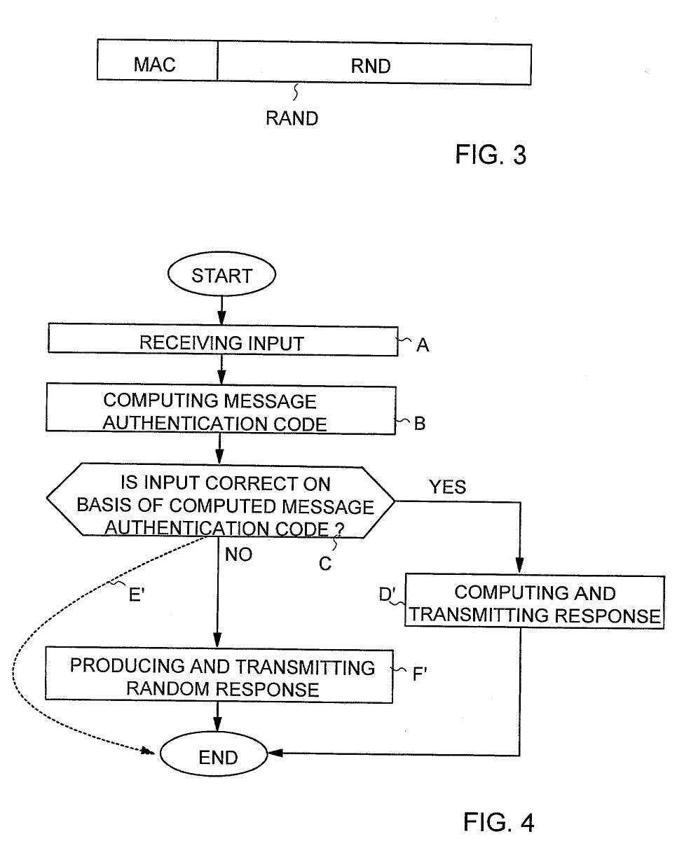

In block B, a message authentication code is computed according to the input RAND and a predetermined checking algorithm. The checking algorithm used should be selected such that it can be concluded whether or not the input is correct on the basis of the result of the computation. Such a checking can be carried out, for example, by predetermining that the input RAND always consists of two parts (as shown by FIG. 3), thus comprising a random number RND and message authentication code MAC computed by the predetermined checking algorithm. Hence, in block B, the part RND used for computing the message authentication code can be retrieved from the input RAND.

After computing the message authentication code, it is checked in block C whether the part MAC remaining of the input corresponds to the computed message authentication code. If the input is incorrect on the basis of the computed message authentication code, it can be concluded that the input originates from an external attacker.

The flow diagram of FIG. 1 thus enables an input originating from an external attacker to be identified, which means that the authentication process may from now onwards proceed such that the external attacker will not be provided with a sufficient amount of information for him or her to crack the secret key.

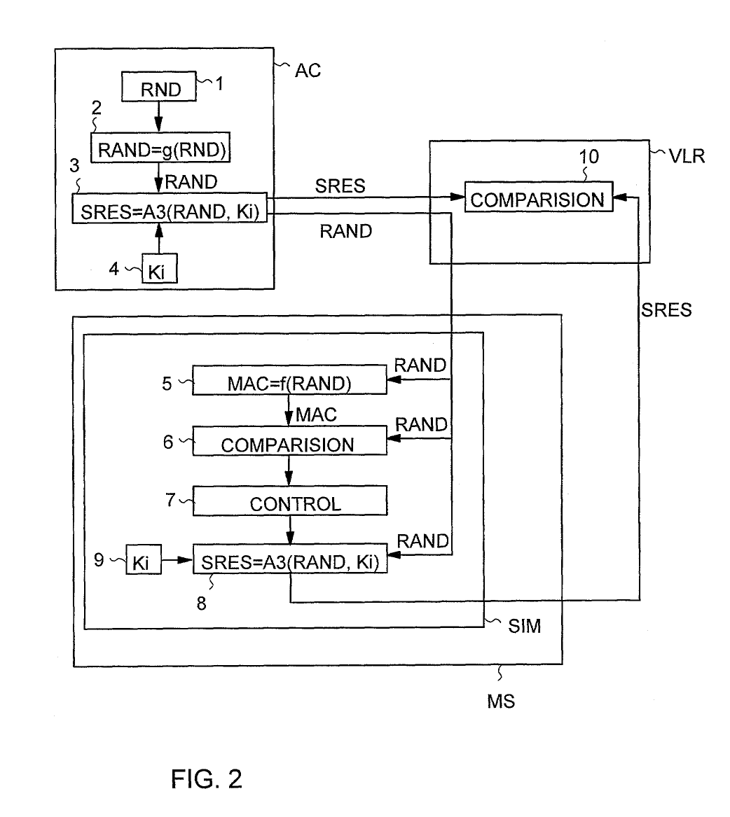

FIG. 2 is a block diagram showing a first preferred embodiment of a system of the invention. The system of FIG. 2 may be a GSM system, for example.

In the case of FIG. 2, a majority of the authentication equipment of the system is arranged in a special authentication centre AC which, in connection with the GSM system, may be located in connection with an HLR (Home Location Register), for example. In the GSM system, the subscriber station is authenticated by a VLR such that the VLR receives from the authentication centre AC an input RAND and response SRES enabling the VLR to authenticate the subscriber station MS.

The authentication centre AC of FIG. 2 comprises a random number generator 1 for generating a random number RND to a counter 2. The counter 2 computes a MAC (Message Authentication Code) on the basis of the random number RND and a first predetermined algorithm g. Next, the counter 2 forms an input RAND from the random number RND and the message authentication code MAC. In the exemplary case of FIG. 2, the input RAND thus consists of two parts. The input is illustrated in FIG. 3.

The authentication centre AC comprises a memory 4 with the secret key stored therein of all those subscriber stations in the authentication of which the authentication centre participates. In practice, the authentication centre can be operator-specific, in which case all secret keys of the subscriber stations of the operator have been stored in the memory of the authentication centre. In the case of FIG. 2, the secret key Ki of the subscriber station MS consisting of a mobile station has been stored in the memory. The authentication centre supplies the secret key Ki retrieved from the memory 4 and the input RAND produced by the counter 2 to a counter 3.

The counter 3 computes a response SRES on the basis of the secret key Ki, input RAND and authentication algorithm A3. The authentication centre transmits the input RAND and response SRES to the VLR.

In order to authenticate the subscriber station MS, the VLR transmits the input RAND received from the authentication centre to the subscriber station MS. The VLR stores the response received from the authentication centre in the memory such that it is available for a comparing element 10.

The input RAND received by the subscriber station MS is conveyed to a counter 5 located on the SIM card of the subscriber station MS. The counter 5 then computes a message authentication code by utilizing the predetermined part of the input and a checking algorithm f. In the embodiment of FIG. 2, it is assumed that the structure of the input RAND produced by the authentication centre AC is similar to that in FIG. 2, i.e. the input consists of the random number RND generated by the random number generator 1 and the message authentication code MAC computed by the algorithm g(RND). The subscriber station checking algorithm f then retrieves the first part RND of the input RAND and next computes a message authentication code MAC in a similar manner to that used by the counter 2 of the authentication centre, i.e. by the algorithm g(RND). The counter 5 supplies the computed message authentication code MAC to a comparing unit 6. Next, the comparing unit compares the message authentication code MAC computed by the counter 5 with the message authentication code MAC in the input RAND. If the comparing unit 6 detects that the message authentication code computed by the counter corresponds to the part MAC remaining of the input, the comparing means 6 indicates to a control unit 7 that the input RAND is correct.

If the control unit 7 detects that the input is correct, it activates a counter 8 to compute a response to the input RAND. The counter 8 computes the response SRES on the basis of the input RAND, subscriber-station-specific secret key Ki stored in a memory 9 and authentication algorithm A3. The algorithm is thus the same algorithm A3 and the parameters are thus the same parameters as the counter 3 that the authentication centre used. The subscriber station MS thus produces the response SRES transmitted to the VLR which corresponds to the response SRES transmitted by the authentication centre. When, after the comparison, the comparing unit 10 of the VLR detects that the responses are identical, it concludes that the subscriber station MS has been authenticated.

If, on the other hand, the comparing unit 6 indicates to the control unit 7 that the input RAND is incorrect, the input has most likely been supplied by an external attacker. In such a case, the control unit interrupts the process for authenticating the subscriber station such that no response will be transmitted by the subscriber station. Alternatively, the control unit 7 can then activate a random response to be forwarded. The random response herein refers to any response which resembles a correct one. Such a random response may, for example, comprise a random number or a response computed by an algorithm. The point is that the response is not computed by the authentication algorithm A3, secret key Ki and input RAND. If this was the case, the external attacker would be provided with the real response to the supplied input, which might assist in cracking the secret key. If, on the other hand, the external attacker is provided with a random response resembling (i.e. the length of the response equals the length of the real response, etc.) the real response, the external attacker will never know that the response is an incorrect one.

The system of FIG. 2 is preferable in that the authentication centre of the invention shown therein can also be used in connection with existing, in other words old, subscriber stations. This is also feasible when the input RAND is selected such that its length corresponds with the input supplied to the old subscriber stations. Naturally, the old subscriber stations are incapable of checking whether or not the response SRES is correct but they are, however, capable of computing the response SRES from the input comprising the message authentication code.

The blocks shown in the block diagram of FIG. 2 may comprise electronic circuits or, alternatively, one or more blocks may be implemented by software. Hence, no two separate counters, for example, are necessary at the subscriber station or the authentication centre, for example, but the counters can be implemented, for example, by one processor and computer program in a manner known per se.

Although it has been described in connection with FIG. 2 that the SIM card of the subscriber station comprises the necessary parts for producing a response in connection with authentication, it is, of course, possible that these parts are, instead of the SIM card, arranged in the subscriber station. Such a solution is relevant particularly in a system comprising no SIM cards at all.

FIG. 3 illustrates an input utilized in authenticating a subscriber station. In the system of FIG. 2, for example, the counter 2 can produce such an input by utilizing a random number RND and algorithm g. Applied to the GSM system, the total length of the input RAND is 16 bytes. According to the invention, the length of the random number RND can then be 8 to 14 bytes, for example. The length of the message authentication code MAC computed on the basis of the random number and algorithm g can correspondingly be 2 to 8 bytes.

When the subscriber station of the invention receives the input of FIG. 3, it computes a message authentication code by utilizing the checking algorithm and the predetermined part of the input, i.e. the random number RND of the input. If the message authentication code computed by the subscriber station corresponds to the part remaining of the input, i.e. the message authentication code MAC, the subscriber station concludes that the input is correct.

FIG. 4 is a flow diagram showing a second preferred embodiment of the method of the invention. The flow diagram of FIG. 4 can be utilized in processing an authentication message in the subscriber station of FIG. 2, for example.

Blocks A to C in FIG. 4 are similar to blocks A to C in FIG. 1, i.e. in those blocks, it is checked whether or not the received input is correct on the basis of the computed message authentication code.

If, in block C, it is found out that the input is correct on the basis of the computed message authentication code, a response SRES is computed and forwarded in block D′. The response is computed on the basis of the predetermined authentication algorithm A3, secret key Ki and input RAND.

If, on the other hand, it is detected in block C that the input RAND is incorrect on the basis of the message authentication code, the input RAND most likely originates from an external attacker who tries to crack the secret key used in the authentication. According to the invention, two alternate ways exist as to how to proceed.

The first alternative is designated by arrow E′, wherein the processing of the authentication message is interrupted. No response will then be transmitted to the authentication message. Consequently, the external attacker receives no response to the input, which means that the attacker is unable to collect any statistics about the inputs and responses or use such statistics for cracking the secret key.

The second alternative is shown in block F′, wherein a random response is produced to the input RAND and forwarded. The random response can be any response which resembles a real response and which has not been computed in a similar manner to the real response (cf. block D′). Consequently, the random response can be directly produced by the random number generator, or it can be computed from the input by utilizing a suitable algorithm and input. The external attacker will thus receive an incorrect response, the attacker not knowing this, however.

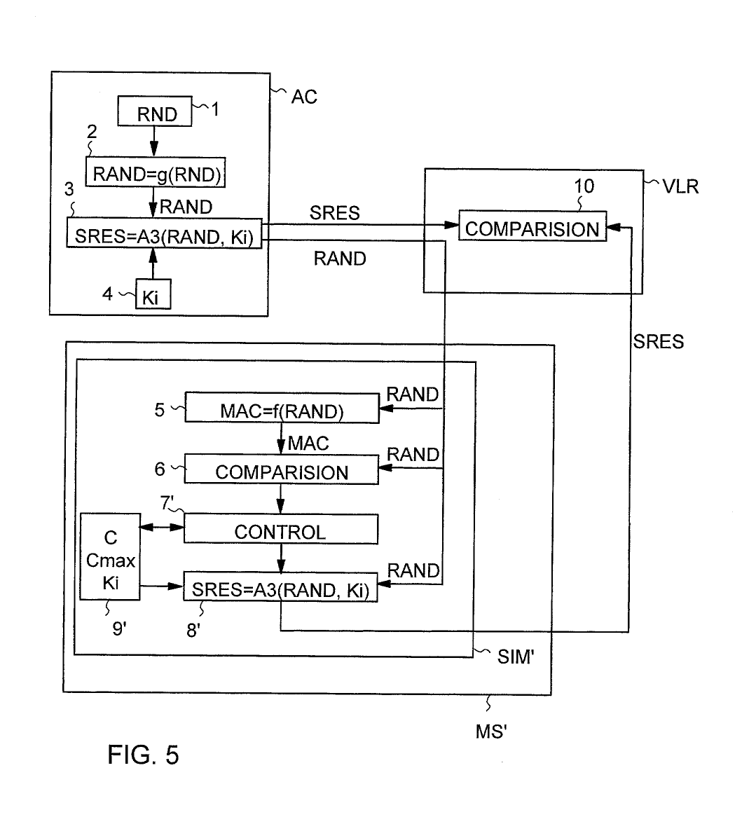

FIG. 5 is a block diagram showing a second preferred embodiment of the system of the invention. In the embodiment of FIG. 5, the authentication centre AC and the visitor location register VLR are similar to the authentication centre and visitor location register VLR shown in the embodiment of FIG. 2. A similar input to that described in connection with the embodiment of FIG. 2 is thus transmitted to a subscriber station MS′.

A SIM card SIM′ located in the subscriber station MS′ of FIG. 5 is also highly similar to the SIM card described in connection with FIG. 2. The embodiment of FIG. 5 differs from the case of FIG. 2 in that the SIM′ card of the subscriber station maintains a counter function concerning the number of incorrect inputs.

The input RAND received by the subscriber station MS′ is conveyed to the counter 5 in the SIM card thereof. The counter 5 then computes a message authentication code by utilizing the predetermined part of the input and checking algorithm f. In the embodiment of FIG. 5, it is assumed that the structure of the input RAND produced by the authentication centre AC is similar to that of FIG. 3, i.e. the input consists of the random number RND generated by the random number generator 1 and message authentication code MAC computed by the algorithm g(RND). The subscriber station checking algorithm f then retrieves the first part RND of the input RAND, and then computes a message authentication code MAC in a similar manner to that used by the counter 2 of the authentication centre, i.e. by the algorithm g(RND). The counter 5 supplies the computed message authentication code MAC to the comparing unit 6. Next, the comparing unit compares the message authentication code MAC computed by the counter 5 with the message authentication code MAC in the input RAND. If the comparing unit 6 detects that the message authentication code computed by the counter corresponds to the part MAC remaining of the input, the comparing means 6 indicates to a control unit 7′ that the input RAND is correct.

If the control unit 7′ detects that the input is correct, it activates a counter 8′ to compute a response to the input RAND. The counter 8′ computes the response SRES on the basis of the input RAND, subscriber-station-specific secret key Ki stored in a memory 9′ and authentication algorithm A3. The algorithm is thus the same algorithm A3 and the parameters are thus the same parameters as the counter 3 of the authentication centre used. Consequently, the subscriber station MS produces the response SRES transmitted to the VLR which corresponds to the response SRES transmitted by the authentication centre. When, after the comparison, the comparing unit 10 of the VLR detects that the responses are identical, it concludes that the subscriber station MS has been authenticated.

If, on the other hand, the comparing unit 6 indicates to the control unit 7′ that the input RAND is incorrect, the response is most likely supplied by an external attacker. The control unit 7′ then updates the counter function of the subscriber station for keeping a record of the number of received incorrect inputs. In the exemplary case of FIG. 5, this may be carried out by means of variable C stored in the memory 9′ and a limit value Cmax. When the SIM card SIM′ was first put to use, variable C was given an initial value of zero stored in the memory 9′. Similarly, the variable Cmax was given e.g. a value of 1000 stored in the memory 9′. When the comparing unit 6 indicates that the received input is incorrect, the control unit 7′ increases the value of variable C by one, and it further compares the new value of variable C with the maximum value Cmax. If the maximum value has been reached, the control unit locks the operation of the SIM card such that the SIM card no longer produces correct responses to the received inputs RAND. In practice, this may be carried out such that the SIM card no longer produces responses at all, or the SIM card will continue by producing random responses only, or the SIM card will only produce an announcement indicating that it is locked.

If the control unit 7′ has been informed of an incorrect response by the comparing unit, and if variable C has not reached the maximum value Cmax in connection with the counter function update, the control unit may operate in many alternate ways, depending on the case. An alternative is that the control unit interrupts the process of authenticating the subscriber station such that the subscriber station will no longer transmit responses. Alternatively, the control unit 7′ may in a similar case activate a random response to be forwarded. The random response herein refers to any response which resembles a real response. Such a random response may, for example, comprise a random number and a response computed by an algorithm. The point is that the response is not computed by the authentication algorithm A3, secret key Ki and input RAND. If this was the case, the external attacker would be provided with the real response to the supplied input, which might assist in cracking the secret key. If, on the other hand, the external attacker is provided with a random response resembling (i.e. the length of the response equals the length of the real response, etc.) the real response, the external attacker will never know that the response is an incorrect one.

The blocks shown in the block diagram of FIG. 5 may consist of electronic circuits, or, alternatively, one or more blocks may be implemented by software. Hence, no two separate counters, for example, are necessary at the subscriber station or the authentication centre, for example, but the counters can be implemented by one processor and computer program in a manner known per se.

Although it has been described in connection with FIG. 5 that the SIM card of the subscriber station comprises the necessary parts for producing a response in connection with authentication, it is, of course, possible that these parts are, instead of the SIM card, arranged in the subscriber station. Such a solution is relevant particularly in a system comprising no SIM cards at all.

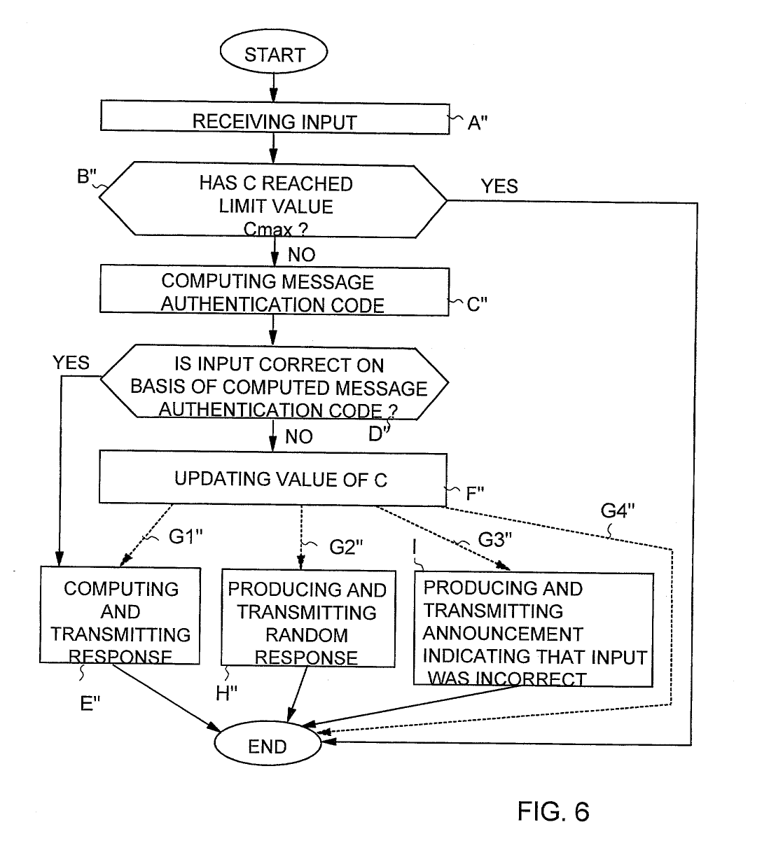

FIG. 6 is a flow diagram showing a third preferred embodiment of the method of the invention. The flow diagram of FIG. 6 may be utilized, for example, in the subscriber station of FIG. 5 for processing an authentication message. A predetermined variable Cmax indicating the highest allowed number of incorrect inputs has then been stored in the subscriber station (or the SIM card thereof) when they were being set up. In addition, variable C to keep a record of received incorrect responses is set to a predetermined initial value.

In block A″ of FIG. 6, an authentication message comprising the input RAND is received.

In block B″, it is checked whether or not variable C utilized by the counter function has received the limit value Cmax. If so, this means that the highest allowed number of received incorrect inputs Cmax has already been reached, which means that the authentication process is interrupted. Otherwise, the process proceeds to block C″.

In block C″, a message authentication code is computed according to the input RAND and a predetermined checking algorithm. The checking algorithm used should be selected such that it can be concluded whether or not the input is correct on the basis of the result of the computation. Such a checking can be carried out, for example, by predetermining that the input RAND always consists of two parts (as shown in FIG. 3), thus comprising a random number RND and a message authentication code MAC computed by the predetermined checking algorithm. In block C″, the part RND used for computing the message authentication code can then be retrieved from the input RAND. After computing the message authentication code, it is checked in block D″ whether or not the part MAC remaining of the input corresponds to the computed message authentication code.

If it is concluded in block D″ that the input is correct on the basis of the computed message authentication code, a response SRES is computed and forwarded in block E″. The response is computed on the basis of the predetermined authentication algorithm A3, secret key Ki and input RAND.

If, on the other hand, it is detected in block D″ that the input RAND is incorrect on the basis of the message authentication code, the input RAND most likely originates from an external attacker trying to crack the secret key used in the authentication. The process then proceeds to block F″.

In block F″, the value of variable C used in the counter function is updated by, for example, increasing or decreasing the value thereof by one (depending on how the initial value of C and Cmax were determined when the counter function was being set up). When the value of variable C has been changed, four alternate ways exist as to how to proceed according to the invention.

The first alternative is designated by arrow G1″, wherein the response is computed and forwarded as usual. An external attacker is then provided with the correct response to the input used by the attacker. The possibility of cracking the secret key by utilizing statistics has, however, been restricted since the counter function can be used for determining that the device to be authenticated only produces e.g. 1000 responses before being locked and stopping the production of correct responses.

The second alternative is designated by arrow G2″, wherein a random response is produced and transmitted in block H″. The random response may be a response generated by the random number generator, or alternatively, a response computed by another key than the secret key used for authentication. The point is that the external attacker is unable to conclude whether or not the response is correct on the basis of the response.

The third alternative is designated by arrow G3″, i.e. an announcement is produced and transmitted in block I″ to indicate that the input is incorrect.

The fourth alternative is designated by G4″, wherein the processing of the authentication message is interrupted. No response is then transmitted to the authentication message. The external attacker will thus receive no response to the input, which means that the attacker is unable to collect any statistics on the inputs and responses or utilize such statistics for cracking the secret key.

The flow diagram in FIG. 6 shows that the comparison of variable C with the limit value Cmax is carried out immediately after receiving the input in block B″. Naturally, this is only one example of how the comparison can be implemented. Many different alternatives thus exist, an alternative being, for example, that the comparison between variable C used by the counter function and the limit value Cmax is carried out only after the received response has been found incorrect and the value of the counter function has been updated.

It is to be understood that the above description and the related drawings are only intended to illustrate the present invention. It is obvious to one skilled in the art that the invention can be modified in various ways without deviating from the scope and spirit of the invention disclosed in the attached claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method for identifying an authentication message generated by an external attacker, the method comprising receiving the authenticating message comprising an input, the method comprising checking the correctness of the input by computing a message authentication code by utilizing the input and a checking algorithm, and identifying the authentication message as being generated by the external attacker if the input is incorrect on the basis of the message authentication code.

2. A method as claimed in claim 1, further comprising computing a response by utilizing an authentication algorithm, the input and a secret key, and forwarding said response if the input is correct on the basis of the message authentication code.

3. A method as claimed in claim 1, further comprising maintaining a counter function to keep a record of the number of inputs that are incorrect on the basis of the message authentication code, and locking the authentication function of the device to be authenticated such that the device to be authenticated no longer produces correct responses to the inputs in the authentication messages if the counter function indicates that the number of incorrect inputs has reached a predetermined limit value.

4. A method as claimed in claim 1, further comprising producing and forwarding a random response if the input is incorrect on the basis of the message authentication code.

5. A method as claimed in claim 4, wherein said random response is a random number.

6. A method as claimed in claim 4, wherein said random response is computed by utilizing the input and a predetermined algorithm.

7. A telecommunication system comprising: at least one subscriber station comprising a counter and a memory with a subscriber-station-specific secret key stored therein, and authentication means for authenticating said subscriber station, the authentication means comprising a random number generator, a counter and a memory with the subscriber-station-specific secret key of said at least one subscriber station stored therein, the authentication means:
computes a response on the basis of an input, an authentication algorithm and the subscriber-station-specific secret key stored in the memory of the authentication means,
transmits said input to said subscriber station, and
indicates that the subscriber station has been authenticated if the authentication means receive from the subscriber station a response which corresponds to the response computed by the authentication means, wherein the authentication means are arranged to compute said input by utilizing a random number generated by the random number generator and a first algorithm, and that the subscriber station
checks the correctness of the received input by computing a message authentication code by utilizing the input and a checking algorithm,
computes a response to be transmitted to the authentication means by the subscriber station by utilizing the authentication algorithm, said secret key stored in the memory of the subscriber station and the input if the input is correct on the basis of the message authentication code.

8. A system as claimed in claim 7, wherein the subscriber station:
maintains a counter function to keep a record of the number of inputs that are incorrect on the basis of the message authentication code, and
locks such that the subscriber station no longer produces correct responses to the received inputs if the counter function indicates that the number of incorrect inputs has reached a predetermined limit value.

9. A system as claimed in claim 7, wherein the subscriber station computes a random response to be transmitted to the authentication means by the subscriber station if the input is incorrect on the basis of the message authentication code.

10. A system as claimed in claim 7, wherein the subscriber station transmits no response to the authentication means if the input is incorrect on the basis of the message authentication code.

11. A system as claimed in claim 7, wherein said system is a mobile communication system.

12. An authentication centre in a telecommunication system, the authentication centre comprising:
a random number generator
a counter and
a memory with subscriber station-specific secret keys of subscriber stations stored therein, and generating an input and a response necessary for authenticating a particular subscriber station, and in order to produce the response the authentication centre:
retrieves from the memory the secret key of the subscriber station to be authenticated, and
computes the response by utilizing the secret key retrieved from the memory, said input and an authentication algorithm, wherein the authentication centre is arranged to produce said input by utilizing a random number generated by the random number generator and a first algorithm.

13. A subscriber station in a telecommunication system which, for authenticating the subscriber station, comprises:
a memory with a secret key stored therein,
means for receiving an input and
a counter wherein the subscriber station is arranged to check the correctness of the input by computing a message authentication code by utilizing the input and a checking algorithm, and the counter is arranged to compute a response to be forwarded by the subscriber station by utilizing an authentication algorithm, said secret key and said input if the input is correct on the basis of the message authentication code.

14. A subscriber station as claimed in claim 13, wherein the subscriber station:
maintains a counter function to keep a record of the number of inputs that are incorrect on the basis of the message authentication code, and
locks such that the subscriber station no longer produces correct responses to the received inputs if the counter function indicates that the number of incorrect inputs has reached a predetermined limit value.

15. A subscriber station as claimed in claim 13, wherein the subscriber station checks the correctness of the input by computing the message authentication code on the basis of a predetermined part of the input and by comparing said message authentication code with the part remaining of the input, whereby the input is correct if the part remaining of the input corresponds to the message authentication code.

16. A subscriber station as claimed in claim 13, wherein said subscriber station is a subscriber station in a mobile communication system, and that the memory and/or the counter are arranged on an SIM card detachably attached to the subscriber station.

17. A subscriber station as claimed in claim 13, wherein the counter is arranged to compute a random response to be forwarded by the subscriber station if the input is incorrect on the basis of the message authentication code.

18. A SIM card comprising a counter and a memory with a secret key stored therein, and an inlet for receiving an input, wherein the SIM card:
checks the correctness of the received input by computing a message authentication code by utilizing the input and a checking algorithm, and compute a response to be forwarded by the SIM card by utilizing an authentication algorithm, said secret key and said input if the input is correct on the basis of the message authentication code.

19. A SIM card as claimed in claim 18, wherein the SIM card:
maintains a counter function to keep a record of the number of inputs that are incorrect on the basis of the message authentication code, and
locks such that the SIM card no longer produces correct responses to the received inputs if the counter function indicates that the number of incorrect inputs has reached a predetermined limit value.

20. A SIM card as claimed in claim 17, wherein the counter computes a random response to be forwarded by the subscriber station if the input is incorrect on the basis of the message authentication code.
